(19) United States
(12) Patent Application Publication
(10) Pub. No.: US 2013/0081881 A1
(43) Pub. Date: Apr. 4, 2013

(54) PROTECTIVE INSERTS FOR A ROLLER CONE BIT

(71) Applicants: Amnach Kongamnach, Lavon, TX (US); Inpeng Bouaphanh, Carrollton, TX (US)

(72) Inventors: Amnach Kongamnach, Lavon, TX (US); Inpeng Bouaphanh, Carrollton, TX (US)

(73) Assignee: Varel International, Ind., L.P., Carrollton, TX (US)

(21) Appl. No.: 13/588,575

(22) Filed: Aug. 17, 2012

Related U.S. Application Data
(60) Provisional application No. 61/541,931, filed on Sep. 30, 2011.

(51) Int. Cl. E21B 10/52; B23P 11/00; B23P 15/28; E21B 10/08; B32B 38/04

(52) U.S. Cl. 175/374; 156/252; 76/108.4; 29/525

(57) ABSTRACT

A rolling cone cutter for a roller cone earth-boring bit has a generally conical body. The generally conical body defines a plurality of lands and grooves. Each land supports a circumferential row of primary cutter elements. At least one of the plurality of lands has a land sidewall. The land sidewall defines a boundary of an adjacent groove. A plurality of protective inserts are disposed within the land sidewall. The protective inserts may reduce erosion of the land sidewall. One or more protective inserts may be disposed between a pair of primary cutters.

### PRIORITY CLAIM

This application claims priority from U.S. Provisional Application Ser. No. 61/541,931, filed on Sep. 30, 2011, which is hereby incorporated herein by reference in its entirety.

### TECHNICAL FIELD

The present invention relates generally to drilling a wellbore, and more particularly to improving the erosion resistance and reducing loss of the primary cutters of a roller cone bit.

### BACKGROUND

Drill bits used in earth boring operations undergo high stresses and forces. A roller cone bit may be employed to drill through hard earth formations such as rock and coal. In breaking apart these substances from the formation, these substances may be abrasive and cause certain portions of the roller cone bit to erode. When portions of the bit supporting the primary cutters erode, primary cutters may separate from the bit and be lost in the wellbore. The loss of primary cutters reduces the drilling effectiveness of the bit, and their replacement may be costly and time consuming.

Reference is made to U.S. Pat. No. 6,176,329 to Portwood, which discloses a drill bit with ridge-cutting cutter elements. The ridge-cutting cutter elements extend from a land and are interspersed among the primary cutter elements also extending from that land.

### SUMMARY

Erosion resistant rolling cone cutters of a roller cone earth-boring bit are presented. Specifically, erosion of a land that may cause undercutting and eventual loss of a primary cutting element may be reduced by using durable protective inserts disposed within a land sidewall. A preferred, but non-limiting, embodiment of a rolling cone cutter is described.

In an embodiment, a rolling cone cutter for a roller cone earth-boring bit has a generally conical body. The generally conical body defines a plurality of lands and grooves. Each land supports a circumferential row of primary cutter elements. At least one of the plurality of lands has a land sidewall. The land sidewall defines a boundary of an adjacent groove. A plurality of protective inserts are disposed within the land sidewall. The protective inserts may reduce erosion of the land sidewall. One or more protective inserts may be disposed between a pair of primary cutters.

The protective inserts may be made of tungsten carbide. They may be recessed within, flush with, or extend beyond the land sidewall. A tip of the protective insert may be generally flat or, in certain embodiments, may be generally dome shaped.

A method for increasing the erosion resistance of a rolling cone cutter of a roller cone bit is also disclosed. The method includes forming a body of a rolling cone cutter that has a plurality of lands and a plurality of grooves. The bit body may be formed of a hardened steel. Each land may be adaptable to support a circumferential row of primary cutter elements. At least one of the lands has a land sidewall that defines a boundary of an adjacent groove. A plurality of spaced apart holes may be formed in the land sidewall. Then, a protective insert may be inserted into each of the holes in the land sidewall.

### BRIEF DESCRIPTION OF THE DRAWINGS

FIG. 1 is an isometric view of a roller cone bit according to an embodiment of the present disclosure;

FIG. 2 is an isometric view of three rolling cone cutters that may be used with a roller cone bit according to an embodiment of the present disclosure, each rolling cone cutter includes protective inserts disposed within the sidewall of one or more lands;

FIGS. 3A and 3B illustrate a detailed view of a portion of one of the rolling cone cutters of FIG. 2;

FIG. 4 illustrates a 360° rotation of rolling cone cutters, with one of the rolling cone cutters illustrated with protective inserts according to an embodiment of the present disclosure; and

FIGS. 5A and 5B illustrate alternate embodiments of protective inserts according to the present disclosure.

### DETAILED DESCRIPTION OF THE DRAWINGS

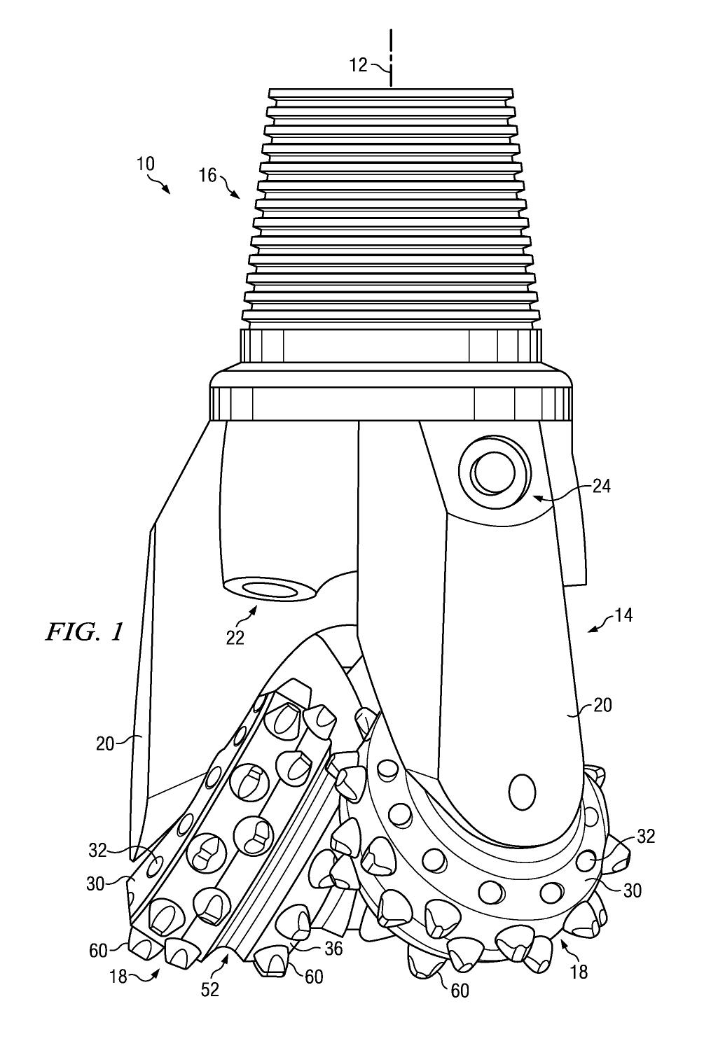

Reference is now made to FIG. 1, which shows a roller cone bit 10 for earth-boring. The roller cone bit 10 has a central axis 12 and a bit body 14. The bit body 14 includes a threaded portion 16 on its upper end for securing the bit 10 to the drill string (not shown). The roller cone bit 10 has a predetermined gage diameter as defined by three rolling cone cutters 18, two of which are visible in FIG. 1. Each rolling cone cutter 18 is rotatably mounted on bearing shafts that depend from the bit body 14. The bit body 14 also includes three sections or legs 20 (two legs 20 are shown in FIG. 1) that are welded together to form the bit body 14. The bit further includes one or more nozzles 22. The nozzles 22 direct drilling fluid toward the bottom of the bore hole and around rolling cone cutters 18. The roller cone bit 10 also may include one or more lubricant reservoirs 24 that supply lubricant to the bearings of each rolling cone cuter 18. The lubricant is sealed within, and the drilling fluid is excluded by, an annular seal that is disposed internal to the rolling cone cutter 18.

Each cutter 18 includes a heel surface 30 that is adapted to retain heel cutter elements 32 that scrape or ream the sidewall of the borehole as cutters 18 rotate about the borehole bottom.

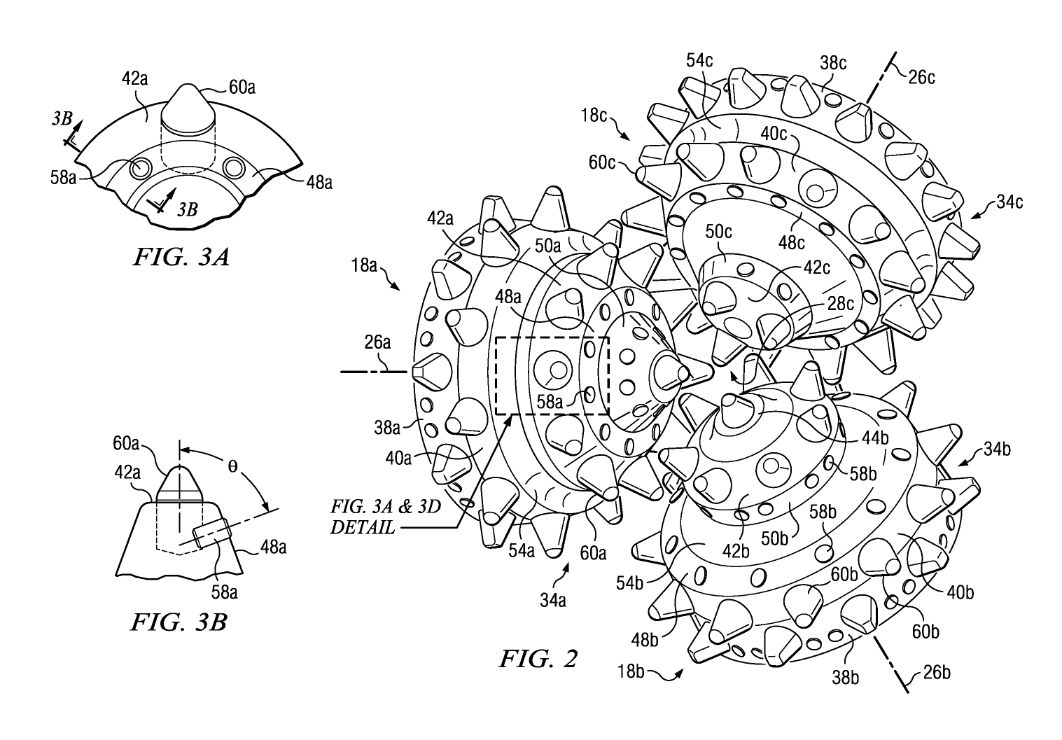

Referring now to FIG. 2 in conjunction with FIG. 1, each of the three rolling cone cutters 18a, 18b, and 18c are visible. Each rolling cone cutter 18 is rotatably mounted on a cantilevered pin or journal, and each has a respective axis of rotation 26a, 26b, and 26c, each of which is orientated downwardly and inwardly toward the center of the roller cone bit 10. Each rolling cone cutter 18a, 18b, and 18c rotates relative to the pin by ball bearings internal to the rolling cone cutter 18.

Each rolling cone cutter 18a, 18b, and 18c, defines a generally conical surface with the tip or nose of the cone being generally toward the center of the bit 10. The generally conical surface is adapted to support, among other features, primary cutter elements 60 that gouge or crush the bore hole bottom as the rolling cone cutters 18 rotate about the bore hole. The generally conical surface includes a plurality of ridges referred to as “lands,” and indicated generally in FIG. 1 by reference number 36, and designated more specifically in FIG. 2 as gage lands 38a, 38b, 38c, first inner lands 40a, 40b, 40c, second inner lands 42a, 42b 42c, and nose lands 44 (only 44b is indicated in FIG. 2). Each of these lands support and secure the primary cutter elements 60.

A land may have as its boundary a land sidewall. For example, a first inner land 40b of rolling cone cutter 18b may define first inner land sidewall 48b. Grooves 52 (as generally indicated in FIG. 1 but more specifically indicated as first inner groove 54a, 54b, and 54c with reference to FIG. 2) may also be formed in generally conical cone surface between adjacent lands. It should further be noted that the two respective land sidewalls, such as land sidewalls 48b and 50b of rolling cone cutter 18b, also generally define the boundaries of a groove, such as inner groove 54b. Thus, land sidewalls may also be considered groove sidewalls.

On each rolling cone cutter 18, lands 36 may decrease in diameter the closer they are to the tip or nose of the cone. Thus, gage land 38 may be the largest diameter land. Moving toward the nose of the cone, a first inner land 40 may support a circumferential row of primary cutter elements 60. Moving further toward the nose of the cone, a second inner land 42 may have a diameter less than first inner land 40 and may also support a circumferential row of primary cutters 60. Each cutter 18 may also have a nose land 44 which support a nose row of primary cutters 60. In certain embodiments, a nose row may have only one cutter but still may be referred to as a row.

Adjacent lands of a rolling cone cutter 18 may be separated by a groove 52. For example, referring to FIG. 2, rolling cone cutters 18a, 18b, 18c may each have respective first inner grooves 54a, 54b, 54c, and further toward the nose of the cone, may have a second inner groove.

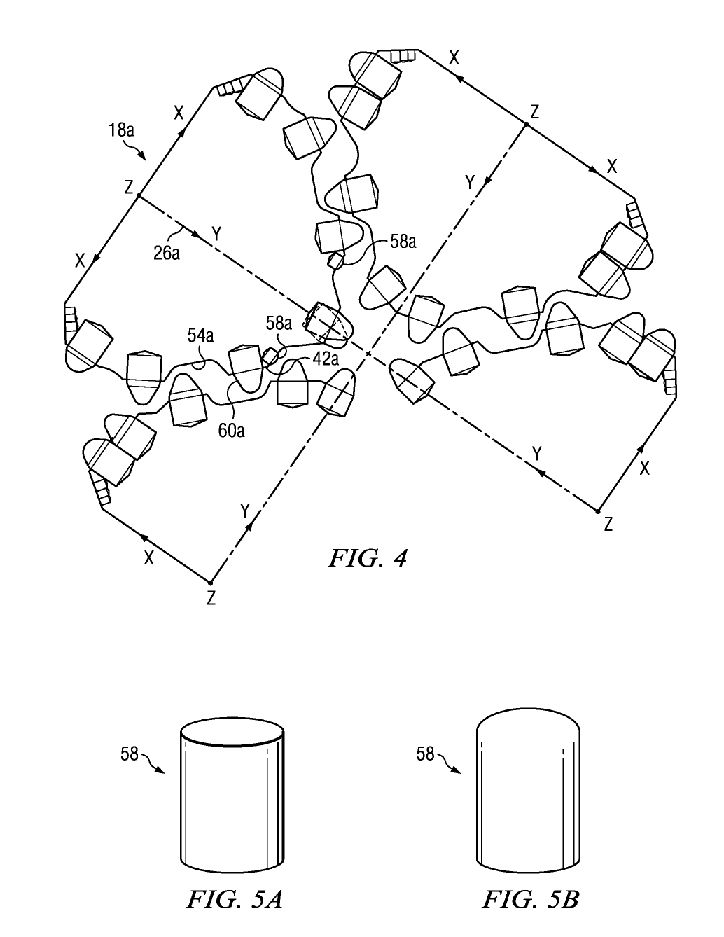

Rolling cone cutters 18a, 18b, and 18c are typically arranged to “intermesh” with each other. More specifically, intermeshing may allow the rolling cone cutters 18a, 18b, 18c to have a larger diameter within the borehole diameter in order to accommodate the maximum possible bearing size. To achieve maximum cone cutter diameter, some of the rows of cutter elements 60 may be arranged to pass between the rows of cutter elements 60 on adjacent cones as the bit rotates. The intermeshing of cutters 18 is illustrated in FIG. 4.

Referring back to FIG. 2, the primary cutter elements 60a of rolling cone cutter 18a extend from second inner land 42a and intermesh with a corresponding inner groove 54b of rolling cone cutter 18b. The groove 54b provides clearance for the primary cutters 60a extending from the second inner land 42a. In operation, the material being drilled through to create the bore hole is disposed between the cutters 60a and the grove 54b. Over time, this material may erode surfaces of the bit body 14. If this erosion is reduced in certain areas, a stronger more durable bit may result.

For example, in drilling through coal, the resulting substance that has been separated from the formation by the roller cone bit 10 may be a slurry-type composition. This slurry may be abrasive and may erode material from the bit body 14, specifically the hardened steel surfaces associated with the lands 36. As an example, the slurry may collect in the space between primary cutter elements 60a (extending from the second inner land 42a of rolling cone cutter 18a) and first inner groove 54b (of rolling cone cutter 18b). This erosion may be exacerbated by the primary cutters 60a forcing the material towards the groove 54b.

This erosion may be particularly problematic if the hardened steel associated with first inner land 40b is eroded away or otherwise weakened. If this happens, the primary cutters 60b extending from the first inner land 40b of cone cutter 18b may separate from the cone. This may result in less effective drilling and/or costly repair or replacement of the rolling cone cutter 18. Two surfaces of the first inner land 40b may be subject to erosion. First, the surface from which the primary cutters 60a extend may be eroded. Also, a land sidewall identified in this example as first inner land sidewall 48b may also be eroded. Erosion of the first inner land sidewall 48b may result in undercutting one or more of the primary cutters 60b extending from the first inner land 40b.

Erosion of a land sidewall may be reduced to create a more durable bit 10. According to an embodiment of the present disclosure, protective inserts 58 may be inserted into the land sidewalls to protect the primary cutters 60b extending from the land defined by that sidewall. These protective inserts 58b may be a generally cylindrical shaped member made of tungsten carbide or other ultra hard, erosion resistant material. The protective inserts 58b may be stronger and more erosion resistant than the hardened steel that forms the body portion of the rolling cone cutter 18b. Thus, continuing with the example above, the primary cutters 60b extending from land 40b may be protected from separating from the rolling cone cutter 18b by a protective insert 58b located in the land sidewall 48b.

The protective insert 58 may be press fit into a hole that is drilled through a land sidewall, such as the inner land sidewall 48b. According to an embodiment, one or more protective inserts 58b may be inserted circumferentially between cutter elements 60b. In this manner, one protective insert 58b may be positioned to protect two primary cutters from undercutting caused by the erosion of the land sidewall 48b. According to an alternate embodiment, two or more protective inserts 58b may be positioned circumferentially between primary cutters 60b. For example, a second inner land sidewall 50b of rolling cone cutter 18b is shown with two protective inserts 58b positioned between primary cutters 60b extending from a second inner land 42b. As an example, more than two protective inserts per cutter element are shown disposed within second land sidewall 50a of rolling cone cutter 18a. In this embodiment, there are more than two protective inserts 58a per each of the primary cutter elements 60a extending from the nose land of rolling cone cutter 18a.

Positioning the protective inserts 58 between primary cutters 60 may avoid the body of the protective insert 58 disposed below the surface of the land sidewall intersecting and interfering with the portion of the primary cutter element 60 that is likewise below the land. See, for example, FIG. 3B, which shows a protective insert 58 disposed in front of an associated primary cutter 60.

The protective insert 58b may be extend beyond a land sidewall, such as inner land sidewall 48b. Also, because the protective inserts 58b do not generally serve a cutting function, they may be flush with or below the land sidewall 48b. According to certain embodiments, the top surface of the protective insert 58b may be disposed from approximately 0.015 inches below the surface of the land sidewall 48b to 0.030 inches above the land sidewall 48b. Consistent with the teaching of the present disclosure, in certain applications the protective insert 58b may extend beyond 0.030 inches above the surface of the land sidewall 48b, provided there is clearance between protective insert 58b and the primary cutter elements 60a of rolling cone cutter 18a that intermesh with the first inner groove 54b (see FIG. 4). This clearance will ensure the primary cutter 60a does not contact protective inserts 58b as the two cone cutters 18a, 18b roll during drilling.

Reference is now made to FIGS. 3A and 3B, which illustrate a detailed view of one of the rolling cone cutters of FIG. 2. FIG. 3A illustrates the rolling cone cutter viewing it perpendicular to the land sidewall 48A. FIG. 3B illustrates a section of the view of FIG. 3A. Referring specifically to FIG. 3B, the angular relationship of the primary cutter 60A and the protective insert 58A is illustrated. As shown in FIG. 3B, the longitudinal axis of the protective insert 58 and the longitudinal axis of the primary cutter 60 may define an angle. Specifically, the angle θ may be approximately equal to an angle formed by an imaginary perpendicular of the land sidewall and an imaginary perpendicular to the land. In certain embodiments, this angle may approximately 45° or greater. For example, 0 may equal approximately 46°.

FIG. 4 illustrates a 360° rotation of rolling cone cutters for a roller cone bit, such as roller cone bit 10. The projection shows a representation of rolling cone cutter 18a. It should be noted that the projection image does not show all the features of rolling cone cutter 18a as illustrated in FIG. 2. The rolling cone cutter 18a is illustrated with two other rolling cone cutters similar to rolling cone cutters 18b and 18c. One of the rolling cone cutters illustrated (the bottom cutter of FIG. 4) has a split 360° projection to better illustrate the intermeshing of rolling cone cutters with one another.

The rolling cone cutter 18a includes primary cutter elements 60a. One row of the primary cutter elements 60a is illustrated extending from second inner land 42a. Also illustrated is a row of protective inserts 58a according to an embodiment of the present disclosure. The protective inserts 58a may reduce erosion of the land sidewall of the second inner land 42a, and thereby protect the primary cutter elements 60a from separating from the cone 18a.

The protective inserts 58 may be press fit into the rolling cone cutter 18. In some embodiments, an adhesive may be used to ensure a secure fit under the high forces of a drilling operation. The adhesive may be a braze or a silver solder material. After the rolling cone cutter 18 is formed, circumferentially spaced apart holes may be drilled in the land sidewalls 48, 50 of the respective cutters 18a, 18b, 18c as shown in FIG. 2. After the holes are drilled, the protective inserts 58 may be press fit into the drilled holes.

Referring to FIGS. 5A and 5B, the protective inserts 58 may have a generally cylindrical body with a tip portion defining the exposed surface of the protective insert 58. The tip portion may be generally flat as shown in FIG. 5A, such that the tip portion is generally parallel with the land sidewall. In other embodiments, the exposed tip portion may be generally dome shaped as shown in FIG. 5B.

Although preferred embodiments of the method and apparatus of the present invention have been illustrated in the accompanying drawings and described in the foregoing detailed description, it will be understood that the invention is not limited to the embodiments disclosed, but is capable of numerous rearrangements, modifications and substitutions without departing from the spirit of the invention as set forth and defined by the following claims.

What is claimed is:

1. A rolling cone cutter for a roller cone earth-boring bit, comprising:
a generally conical body defining a plurality of lands and a plurality of grooves;
each land supporting a circumferential row of primary cutter elements;
at least one land having a land sidewall defining a boundary of an adjacent groove;
a plurality of protective inserts disposed within the land sidewall for reducing erosion of the land sidewall.

2. The rolling cone cutter of claim 1 wherein each one of the plurality of protective inserts comprise tungsten carbide.

3. The rolling cone cutter of claim 1 wherein each one of the plurality of protective inserts has a cylindrical body portion and a tip portion, the tip portion defining a top surface.

4. The rolling cone cutter of claim 3 wherein the top surface is flat.

5. The rolling cone cutter of claim 3 wherein the top surface is dome-shaped.

6. The rolling cone cutter of claim 3 wherein the top surface is recessed below the land sidewall.

7. The rolling cone cutter of claim 3 wherein the top surface is substantially flush with the land sidewall.

8. The rolling cone cutter of claim 3 wherein the top surface extends beyond the land sidewall.

9. The rolling cone cutter of claim 1 wherein only one protective insert is disposed between a pair of the primary cutter elements.

10. The rolling cone cutter of claim 1 wherein at least two protective inserts are disposed between a pair of the primary cutter elements.

11. The rolling cone cutter of claim 1 wherein at least one of the protective inserts includes a cylindrical body portion defining an axis of the protective insert; and
the axis of the protective insert and an axis of at least one of the primary cutter elements form an angle of forty-five degrees or greater.

12. A roller cone bit, comprising,
a plurality of rolling cone cutters,
each rolling cone cutter comprising:
a generally conical body defining a plurality of lands and a plurality of grooves;
each land supporting a circumferential row of primary cutter elements;
at least one land having a land sidewall defining a boundary of an adjacent groove;
a plurality of protective inserts disposed within the land sidewall for reducing erosion of the land sidewall, wherein each of the protective inserts comprise tungsten carbide;
wherein each of the protective inserts includes a cylindrical body portion defining an axis of the protective insert, and
the axis of the protective insert and an axis of the primary cutter element extending from the at least one land form an angle of forty-five degrees or greater.

13. A method for increasing erosion resistance of a rolling cone cutter, comprising:
forming a body of a rolling cone cutter having a plurality of lands and a plurality of grooves, each land adaptable to support a circumferential row of primary cutter elements, at least one land having a land sidewall defining a boundary of an adjacent groove;
forming a plurality of spaced apart holes in the land sidewall; and
inserting a protective insert into each one of the spaced apart holes.

14. The method of claim 13 wherein the protective insert is press fit into one of the spaced apart holes.

15. The method of claim 14 wherein the protective insert is recessed below the land sidewall.

16. The method of claim 14 wherein the protective insert is substantially flush with the land sidewall.

17. The method of claim 14 wherein the protective insert extends beyond the land sidewall.

18. The method of claim 13 wherein adhesive is applied to one of the spaced apart holes or the protective insert before inserting the protective insert into the hole.

19. The method of claim 13 further comprising inserting a plurality of primary cutter elements into the at least one land.

20. The method of claim 13 wherein the protective insert comprises tungsten carbide.
